(19) United States
(12) Patent Application Publication
(10) Pub. No.: US 2026/0230829 A1
(43) Pub. Date: Aug. 6, 2026

(54) METHOD, DEVICE, AND MEDIUM FOR DYNAMIC ZERO TRUST CONNECTION SERVICE

(71) Applicant: Verizon Patent and Licensing Inc., Basking Ridge, NJ (US)

(72) Inventors: Mun Wei Low, Irving, TX (US); Connie P. Grigg, Jacksonville, FL (US); Richard Sellings, Dorking (GB); Frederic Van Keirsbilck, Keerbergen (BE)

(21) Appl. No.: 19/044,737

(22) Filed: Feb. 4, 2025

(51) Int. Cl. H04W 12/60; H04W 76/10

(52) U.S. Cl. CPC H04W 12/66; H04W 76/10

(57) ABSTRACT

A method, a network device, and a non-transitory computer-readable storage medium are described in relation to a dynamic zero trust connection service. The dynamic zero trust connection service may include dynamically applying or not applying zero trust mechanisms at an end device on a per connection basis associated with a data session. The dynamic zero trust connection may include determining whether to establish a secure connection or not based on context and criteria configured in support of the dynamic zero trust connection service. The dynamic zero trust connection service may be implemented by an agent installed at the end device. The dynamic zero trust connection service may include certificate retrieval and termination of secure connection due to inactivity.

### BACKGROUND

Development and design of networks present certain challenges from a network-side perspective and an end device perspective. Typically, end devices are authorized and/or authenticated as a part of network attachment and/or use of an application service.

### BRIEF DESCRIPTION OF THE DRAWINGS

FIG. 1 is a diagram illustrating an exemplary environment in which an exemplary embodiment of a dynamic zero trust connection service may be implemented;

FIG. 2 is a diagram illustrating exemplary components of an exemplary embodiment of the dynamic zero trust connection service of an end device;

FIG. 3 is a diagram illustrating an exemplary process of an exemplary embodiment of the dynamic zero trust connection service;

FIG. 4 is a diagram illustrating another exemplary process of an exemplary embodiment of the dynamic zero trust connection service;

FIG. 5 is a messaging diagram illustrating yet another exemplary process of an exemplary embodiment of the dynamic zero trust connection service;

FIG. 6 is a diagram illustrating exemplary components of a device that may correspond to one or more of the devices illustrated and described herein; and

FIG. 7 is a flow diagram illustrating an exemplary process of an exemplary embodiment of the dynamic zero trust connection service.

### DETAILED DESCRIPTION

The following detailed description refers to the accompanying drawings. The same reference numbers in different drawings may identify the same or similar elements. Also, the following detailed description does not limit the invention.

Zero trust may be considered a security strategy or model that may include enforcement of a security policy for each individual connection between users, end devices, applications, data, and network assets. A zero trust security model may include authenticating user identities, ensuring that every device is compliant with zero trust policies, using network micro segmentation, disallowing implicit trust to applications, application programming interfaces (APIs), among other features.

Typically, current zero trust security models apply security mechanisms to all connections between an end device and a network regardless of the context, conditions, and/or circumstances surrounding the connection-hence zero trust (e.g., “never trust, always verify”). As such, the static and rigid nature of current zero trust security models may lead to the imposition of zero trust mechanisms when such mechanisms may be unnecessary under some circumstances. As a consequence, current zero trust architectures may unnecessarily waste network resources, require significant network resource deployment (e.g., network security devices, etc.), among other considerations to support enforcement of zero trust regardless of the context associated with a connection between the end device and a network.

According to exemplary embodiments, a dynamic zero trust connection service is provided. According to an exemplary embodiment, the dynamic zero trust connection service may include a zero trust connection service. According to an exemplary embodiment, the zero trust connection service may include dynamically applying or not applying zero trust security mechanisms on a per connection basis.

According to an exemplary embodiment, the dynamic zero trust connection service may be provided, at least in part, by an agent, a client, system software, a daemon, and/or similar type of component (referred to simply as an “agent”) that executes at an end device. According to an exemplary embodiment, the agent may include logic that determines whether to establish a secure connection or not based on a criterion or criteria. According to an exemplary embodiment, the agent may establish the secure connection when the end device is using a non-cellular wireless connection, such as a Wi-Fi connection, a Bluetooth connection, or the like, for a data session, as described herein. According to an exemplary embodiment, the agent may establish the secure connection when the end device is using a third-party card (e.g., a subscriber identity module (SIM) card, an embedded SIM (eSIM), or the like), for a data session, as described herein.

According to an exemplary embodiment, the agent may not establish the secure connection when the end device is using a cellular connection with a home network of a user of the end device and/or the end device, for a data session, as described herein. According to an exemplary embodiment, the agent may not establish the secure connection when the end device may be roaming on a third-party wireless network using a profile of the home network provider, operator, or the like, for a data session, as described herein.

According to an exemplary embodiment, the agent may dynamically terminate the secure connection when the criterion or the criteria, as described herein, is satisfied. For example, when the end device performs a handover from a Wi-Fi connection to a cellular connection with the home network, the agent may dynamically terminate the secure connection. According to another example, the agent may dynamically terminate the secure connection due to inactivity. For example, the agent may terminate the secure connection when the end device enters a particular state (e.g., enters a sleep mode, enters a hibernate mode, etc.), remains in a particular state for a threshold period of time (e.g., remains in idle mode for a threshold period, remains in sleep mode for a threshold period, etc.), fails to transmit and/or receive a minimum number of packets during a threshold period, and/or other configurable criteria, as described herein.

According to an exemplary embodiment, the agent may be provisioned with a network address and/or network path to a security network device via which the secure connection may be established, as described herein. According to an exemplary implementation, the secure connection may include an Internet Protocol Security (IPsec) tunnel. According to another exemplary implementation, the secure connection may include Transport Layer Security (TLS), Hypertext Transfer Protocol Secure (HTTPS), or another type of network security protocol and/or mechanism. According to various exemplary implementations, the data session may include a packet data network (PDN) session, a packet data unit (PDU) session, an application session, an over-the-top (OTT) session, a data network (DN) session, or the like, between the end device and a network device. For example, the network device may be implemented as an application server or similar type of network device that may host an end device application, provide an end device application service, asset, or the like.

According to various exemplary embodiments, the agent may or may not be provisioned with security certificates. For example, depending on the method and/or context of installation of the agent, such as pre-installed on the end device, installed as a part of an initial onboarding of the end device with a home network, downloaded after completion of an onboarding procedure, downloaded by a user from an online store, etc., the end device may or may not include security certificates. According to an exemplary embodiment, when the agent is not provisioned with security certificates, the agent may provide a certificate retrieval sub-service of the dynamic zero trust connection service, as described herein. According to an exemplary embodiment, the agent may include logic that generates an end device identifier based on a set of available algorithms and a set of available unique identifiers, as described herein. The agent may use the end device identifier to be authenticated by a network security device. According to an exemplary embodiment, the agent may download and securely store the security certificates after successfully completing the authentication procedure.

According to an exemplary embodiment, the agent may include logic to validate the identity of a user of the end device using biometrics, which may be supported natively on the end device. According to an exemplary embodiment, the agent may be able to secure passkeys and support passwordless authentication. According to an exemplary embodiment, the agent may include logic that supports other services relating to security posture assessment, device analytics, device posture, patch status, location data, and other well-known mechanisms associated with a zero trust architecture.

In view of the foregoing, the dynamic zero trust connection service may dynamically and selectively provide zero trust mechanisms based on configurable criteria, as described herein. The dynamic zero trust connection service may also improve network resource utilization associated with a zero trust architecture (e.g., physical and virtual devices, communication links, tunneling resources, hardware, software, etc.).

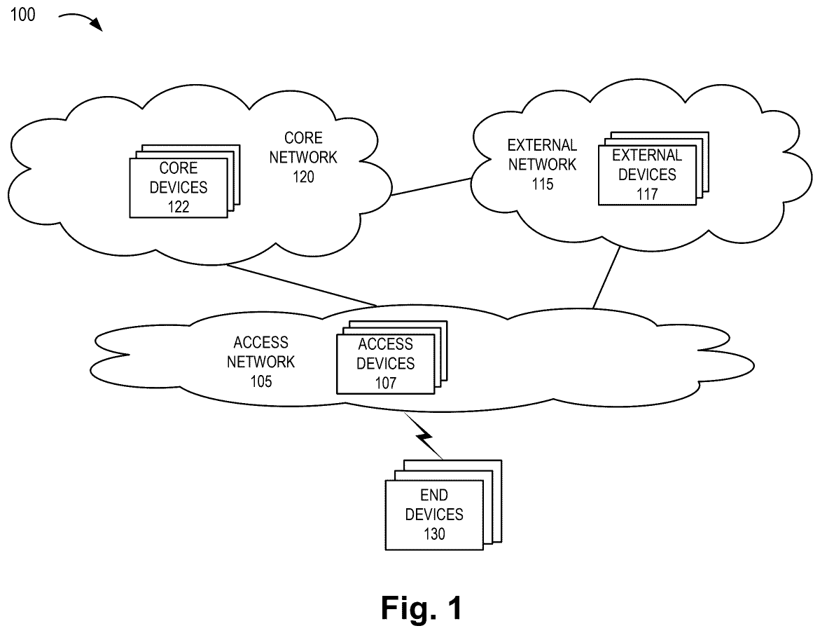

FIG. 1 is a diagram illustrating an exemplary environment 100 in which an exemplary embodiment of dynamic zero trust connection service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7(SS 7 ), an optical network, a wired network, etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, etc.), as well as used to support other types of network elements (e.g., network slices, connections, tunnels, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communication connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the dynamic zero trust connection service may use at least one of these planes. According to various exemplary implementations, the interface of the network device may be a service-based interface, a reference point-based interface, an Open Radio Access Network (O-RAN) interface, a Fifth Generation (5G) interface, another generation of interface (e.g., 5G Advanced, Sixth Generation (6G), Seventh Generation (7G), Fourth Generation (4G), etc.), or some other type of network interface (e.g., proprietary, etc.).

Access network 105 may include one or multiple networks of one or multiple types and technologies. For example, access network 105 may be implemented to include a 5G RAN, a future generation RAN (e.g., a 6G RAN, a 7G RAN, or a subsequent generation RAN), a centralized-RAN (C-RAN), an O-RAN, and/or another type of access network. Access network 105 may include a legacy RAN (e.g., a Third Generation (3G) RAN, a 4G or 4.5 RAN (Long Term Evolution (LTE) Advanced, LTE Advanced Pro), etc.). Access network 105 may communicate with and/or include other types of access networks, such as, for example, a Wi-Fi® network, a local area network (LAN), a Citizens Broadband Radio System (CBRS) network, a cloud RAN, an O-RAN network, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120 including an Evolved Packet Core (EPC) network and/or a Next Generation Core (NGC)/5G core network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., non-standalone (NSA) NR, SA NR, etc.). Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced LTE (eLTE) evolved Node B (eNB), an eNB, a radio network controller (RNC), a radio intelligent controller (RIC), a base station (BS), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 5G advanced wireless station, a 6G wireless station, a 7G wireless station, or another generation of wireless station), or another type of cellular wireless station. Access devices 107 may also include a network device that provides a transport service (e.g., routing and forwarding), such as a router, a switch, or another type of layer 3 (e.g., network layer of the Open Systems Interconnection (OSI) model) network device.

According to some exemplary implementations, access device 107 may include a combined functionality of multiple RATs (e.g., 4G and 5G functionality, 5G and 5G Advanced functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

According to various exemplary implementations, access device 107 may include one or multiple sectors or antennas. The antenna may be implemented according to various configurations, such as single input single output (SISO), single input multiple output (SIMO), multiple input single output (MISO), multiple input multiple output (MIMO), massive MIMO, three dimensional (3D) and adaptive beamforming (also known as full-dimensional agile MIMO), two dimensional (2D) beamforming, antenna spacing, tilt (relative to the ground), radiation pattern, directivity, elevation, planar arrays, and so forth. Depending on the implementation, access device 107 may provide a wireless access service at a cell, a sector, a sub-sector/zone, carrier, and/or other configurable level. For example, the sub-sector/zone level may include multiple divisions of a geographic area of a sector relative to access device 107. By way of further example, the sector may be divided based on proximity to the antenna of access device 107 (e.g., near, mid, far) and/or another criterion. According to another example, radio coverage of a location may be divided based on a Military Grid Reference System (MGRS) or another type of grid system to produce geo-bins. The size and/or shape of each geo-bin may be configurable. The size and/or the shape of a geo-bin may depend on the type of access device 107 (e.g., small cell device versus gNB, etc.), attributes of access device 107 (e.g., antenna configuration, radio frequency band of beam, etc.), and/or other factors (e.g., terrain of the radio covered locale).

External network 115 may include one or multiple networks of one or multiple types and technologies that provide an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an IMS network, a Rich Communication Service (RCS) network, a software defined (SD) network, a virtual network, a packet-switched network, a data center, or other type of network that may provide access to and may host an end device application service.

Depending on the implementation, external network 115 may include various network devices such as external devices 117. For example, external devices 117 may include virtual network devices (e.g., virtualized network functions (VNFs), servers, host devices, containers, hypervisors, virtual machines (VMs), network function virtualization infrastructure (NFVI), and/or other types of virtualization elements, layers, hardware resources, operating systems, engines, etc.) that may be associated with application services for use by end devices (not illustrated). By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). External network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (IoT) services (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, conferencing, instant messaging), video streaming, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an EPC of an LTE network, a future generation core network (e.g., a 5G Advanced, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM) device, a unified data repository (UDR), an authentication server function (AUSF), a network slice selection function (NSSF), a network repository function (NRF), a policy control function (PCF), a network data analytics function (NWDAF), a network exposure function (NEF), a service capability exposure function (SCEF), a lifecycle management (LCM) device, an application function (AF), a mobility management entity (MME), a packet gateway (PGW), an enhanced packet data gateway (ePDG), a serving gateway (SGW), an application function (AF), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5G Advanced, 5G and 6G, etc.), such as an SMF with PGW control plane functionality (e.g., SMF+PGW-C), a UPF with PGW user plane functionality (e.g., UPF+PGW-U), and/or other combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

End device 130 includes a device that may have communication capabilities (e.g., wireless, wired, optical, etc.). End device 130 may or may not have computational capabilities. End device 130 may be implemented as a mobile device, a portable device, a stationary device (e.g., a non-mobile device or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, etc.), a computer (e.g., laptop, palmtop, etc.), a gaming device, a music device, an IoT device, a drone, a smart device, a television, a set top box, a media player or streaming device, a telematics device, or another type of wireless device (e.g., another type of UE). End device 130 may be configured to execute various types of software (e.g., applications, programs, etc.). The number and the types of software may vary among end devices 130. End devices 130 may include “edge-aware” and/or “edge-unaware” application service clients. For purposes of description, end device 130 is not considered a network device.

According to an exemplary embodiment, at least some end devices 130 may include logic of the dynamic zero trust connection service, as described herein. For example, such end devices 130 may include the agent and pre-installed security certificates or retrieved security certificates.

According to an exemplary embodiment, the agent may include logic that determines whether a secure connection is to be established for a data session and subsequent maintenance and termination of the secure connection based on criteria, as described herein. At least in some instances, the criterion or the criteria may necessarily relate to the capabilities or features associated with such end devices 130. For example, according to an exemplary embodiment, the dynamic zero trust connection service may be implemented by end devices 130 that may include cellular connection capability and non-cellular connection capability. For example, the cellular connection capability may include 5G and/or another generation of cellular technology (e.g., 4G, 6G, etc.) and the non-cellular connection capability may include Wi-Fi®, Bluetooth®, UWB, and/or another type of non-cellular wireless technology.

According to another exemplary embodiment, the dynamic zero trust connection service may be implemented by end devices 130 that include a card (e.g., card-capable or card-enabled end device 130). For example, some end devices 130 may include a SIM card, an eSIM, an integrated SIM (iSIM), a Universal Integrated Circuit Card (UICC), an eUICC, an iUICC, a secure element (SE), an integrated trusted execution environment (a TEE), a chip or the like (also referred to, described, or defined simply as a “card”). The card may include hardware and may include various types of data, an application, software, an operating system (OS), and/or other types of executables that may be stored on and executed by the card, for example. The card may also host a profile, which may include subscription data, security authentication and ciphering information, network configuration information (e.g., roaming files/configuration, etc.), applications, algorithms (e.g., encryption, decryption, etc.), and so forth. Typically, the card profile may be owned by a wireless network operator, a wireless service provider, a wireless or cellular carrier, a mobile network operator (MNO), or the like.

According to yet another exemplary embodiment, the dynamic zero trust connection service may be implemented by end devices 130 that operate with an OS of a given set of OSs, such as Android®, iOS®, iPadOS®, MacOS®, Linux®, Windows®, and/or another OS. According to still other exemplary embodiments, the dynamic zero trust connection service may be implemented by end devices 130 that may have other capabilities or components not specifically mentioned herein.

According to an exemplary embodiment, the agent may include logic that provides the certificate retrieval service, as described herein. According to an exemplary embodiment, the agent may include logic that generates an end device identifier based on a set of available algorithms and a set of available unique identifiers. According to an exemplary implementation, the set of algorithms may include hashing algorithms. According to an exemplary implementation, the unique identifiers may include an International Mobile Equipment Identity (IMEI), a Permanent Equipment Identifier (PEI), an Integrated Circuit Card Identifier (ICCID), an International Mobile Subscriber Identity (IMSI), an embedded Identity Document (eID), and a Subscription Permanent Identifier (SUPI), or a sub-combination thereof.

According to an exemplary embodiment, the agent may generate an end device identifier based on a hash algorithm and a particular set of unique identifiers. For example, an end device identifier_1 may be generated by a hashing algorithm that uses the IMEI+the ICCID or the eID+the IMSI. According to another example, an end device identifier_2 may be generated by a hashing algorithm that uses the ICCID or the eID+the IMEI+the IMSI. In this way, the agent may generate multiple end device identifiers using a hashing algorithm with a given permutation of unique identifiers associated with end device 130 as arguments. The agent may use the end device identifier to be authenticated by a network security device. According to an exemplary embodiment, the agent may download and securely store the security certificates after successfully completing the authentication procedure.

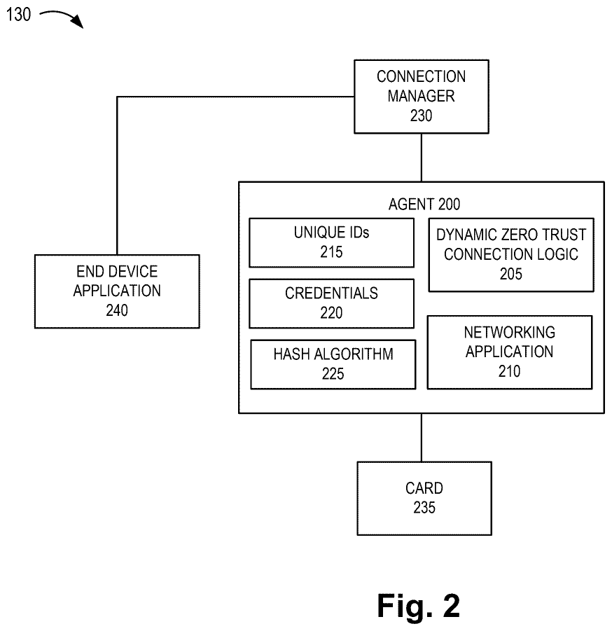

FIG. 2 is a diagram illustrating exemplary components of end device 130 in which an exemplary embodiment of the dynamic zero trust connection service may be implemented. As illustrated, end device 130 may include an agent 200, a connection manager 230, a card 235, and an end device application 240. As further illustrated, agent 200 may include dynamic zero trust connection logic 205, a networking application 210, storage which may securely store unique IDs 215 and credentials 220, and also include a hashing algorithm 225.

FIG. 2 also illustrates exemplary connections or communication paths between components or elements of end device 130. For example, the connections or communication paths may include a hardwire link (e.g., a bus, a shared memory space, etc.), a software link (e.g., inter-process communication (IPC), etc.), or some other type of communicative link (e.g., an application programming interface (API), etc.). The number, type, and arrangement of components and connections/communication paths are exemplary.

Agent 200 may include logic that provides various services of the dynamic zero trust connection service. Agent 200 may include software, such as system software, a daemon, a client, and/or the like, as described herein.

Dynamic zero trust connection logic 205 may include logic that may dynamically apply or not apply zero trust security mechanisms on a per connection basis based on a criterion or criteria, as described herein. For example, dynamic zero trust connection logic 205 may include logic that dynamically establishes and terminates a secure connection for data sessions, as described herein. Dynamic zero trust connection logic 205 may also establish a secure connection for the retrieval of security certificates and the like, as described herein. Dynamic zero trust connection logic 205 may be configured with the criteria used to make determinations regarding the establishment and termination of secure connections.

Networking application 210 may include a client, a daemon, or another type of application that may provide a secure connection with a network device of a network, such as access device 107, external device 117, core device 122, and the like, as described herein.

Unique IDs 215 may include a set of unique identifiers pertaining to end device 130, such as an IMEI, a PEI, an ICCID, an eID, a SUPI, an IMSI, or the like, as described herein.

Credentials 220 may include security or digital certificates, security tokens, and/or another type of security data instance that may be used for authentication. Credentials 220 may store other types of security-related data that may enable one or more other security measures, such as authorization, data integrity, non-repudiation, and so forth. For example, the security-related data may include digital signature, login information, passkeys, and/or the like.

Hashing algorithm 225 may include a commercially available or proprietary hashing algorithm that provides a hash function. According to some exemplary embodiments, hashing algorithm 225 may include multiple hashing algorithms 225, which may be different. According to an exemplary embodiment, hashing algorithm 225 may be configured with a unique algorithm identifier. The unique algorithm identifier may uniquely identify the hashing algorithm and/or a particular permutation of arguments associated with unique identifiers of end device 130. Hashing algorithm 225 may generate an end device identifier based on a permutation of unique identifiers stored in unique IDs 215.

Connection manager 230 may include a component that may manage access and/or establishment of network connections by end device 130 with a network (e.g., access network 105, external network 115, core network 120). According to various exemplary implementations, connection manager 230 may be implemented in or as a modem, a baseband chip, UE Route Selection Policy (URSP) logic, or the like.

Card 235 may include a SIM card, an eSIM, and the like, as described herein. Card 235 may store profiles, such as eSIM profiles, USIM profiles, or the like, among other types of data, applications, etc., as described.

End device application 240 may include a software application, such as a mobile application, a web application, a desktop application, a client application, a native application, a network application, or the like that may provide an application service, as described herein.

The components of end device 130 that provide the dynamic zero trust connection service are exemplary. According to other exemplary embodiments, end device 130 may include additional, fewer, and/or different functional components pertaining to an exemplary embodiment of the dynamic zero trust connection service. Additionally, or alternatively, one or more components may be combined and/or one or more operations, functions, and/or subservices may be divided into one or more dedicated components not illustrated.

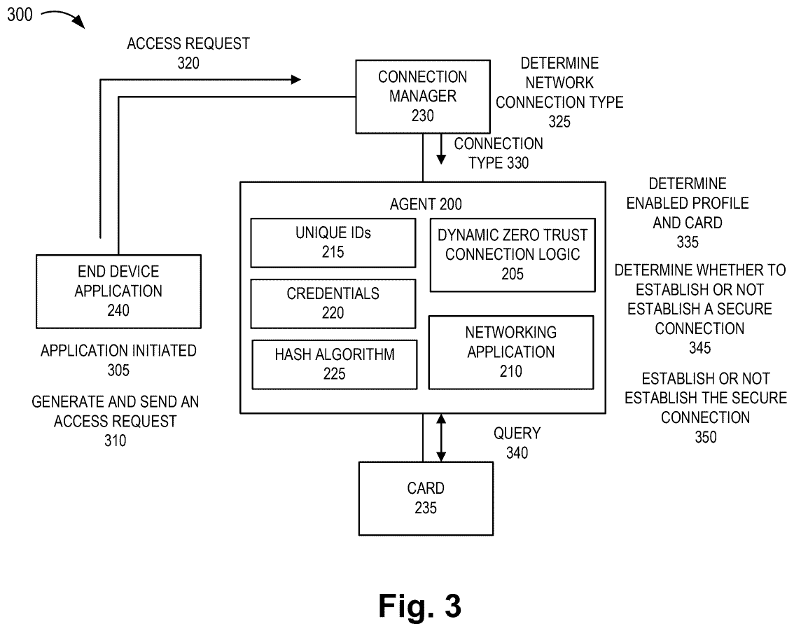

FIG. 3 is a diagram illustrating an exemplary process 300 of an exemplary embodiment of the dynamic zero trust connection service according to an exemplary scenario. Referring to FIG. 3, assume that end device 130 has attached to core network 120 via a Wi-Fi connection. Thereafter, process 300 may include an end device application that is initiated 305. For example, a user (not illustrated) may launch end device application 240 by tapping on an icon of end device application 240. In response, end device application 240 may generate and send an access request 310 to connection manager 230. Access request 320 may include a request for access to a network connection. Access request 320 may include other types of data, such as an application identifier of end device application 240, etc.

In response to receiving access request 320, connection manager 230 may determine a network connection type 325. For example, according to this exemplary scenario, connection manager 230 may identify the current Wi-Fi connection. Connection manager 230 may determine that the current Wi-Fi connection may be used for access request 320. Connection manager 230 may provide a connection type 330 to agent 200. For example, connection type 330 may indicate a Wi-Fi connection. In response, agent 200 may determine an enabled profile and card 335 to be used or associated with the prospective data session. For example, agent 200 may perform a query 340 with card 235. Depending on the end device 130 and/or type of card architecture (e.g., consumer, M2M, IoT, future generation, etc.), the logic of the card profile management service may be implemented as a local profile assistant (LPA), an IoT profile assistant (IPA), a subscription manager (SM), an SM secure routing (SM-SR), or similar functioning element or system application of the card or of end device 130 (also referred to generally as a “profile assistant” or “PA” for description purposes). According to an exemplary implementation, agent 200 may query the profile assistant for card type and profile information. According to this exemplary scenario, the result of query 340 may indicate that card 235 is a third party card using a third party profile.

As further illustrated, agent 200 may determine whether to establish or not establish a secure connection 345 based on connection type 330 and the result of query 340. Agent 200 may establish or not establish the secure connection 350 based on the outcome of the determination. According to this exemplary scenario, agent 200 may establish a secure connection. For example, agent 200 may establish an IPsec tunnel to external device 117 via a security gateway (not illustrated). Agent 200 may perform other zero trust security measures, such as applying TLS, using security certificates and/or other security data instances, and so forth, in order to provide various security-related protections. End device 130 may generate and transmit a session establishment request (e.g., a PDU Session Establishment request, a PDN Session Establishment request, etc.) to the network.

FIG. 3 illustrates an exemplary process 300, however, according to other exemplary embodiments and scenarios, process 300 may include additional operations, fewer operations, and/or different operations. For example, process 300 may include not establishing a secure connection when the criterion or criteria for not establishing the secure connection is satisfied, as described herein.

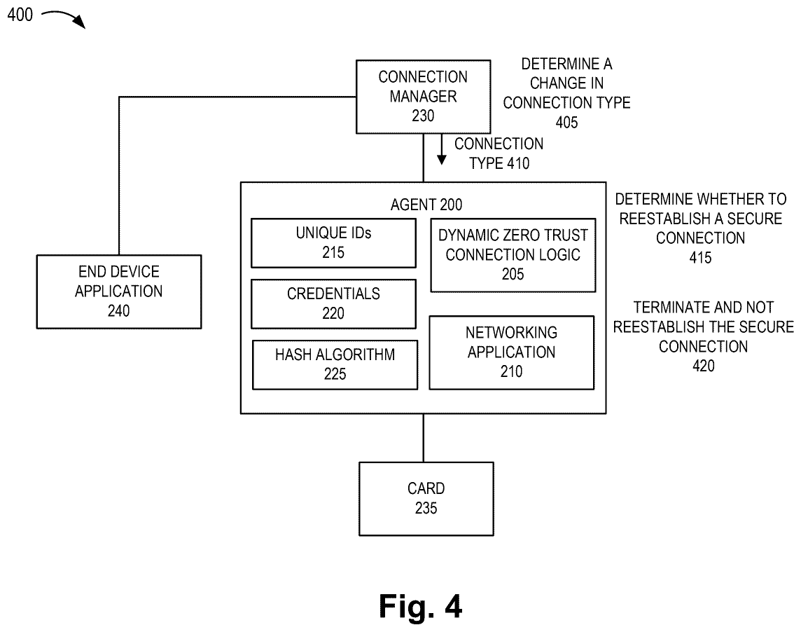

FIG. 4 is a diagram illustrating another exemplary process 400 of an exemplary embodiment of the dynamic zero trust connection service according to an exemplary scenario. Referring to FIG. 4, assume that end device 130 has an ongoing application session with external device 117 via a Bluetooth connection. For example, end device 130 may be tethered. The application session may be supported via a secure connection based on the criteria described herein. Thereafter, the Bluetooth connection may degrade due to user mobility, and end device 130 may initiate a handover procedure to a cellular connection with a home network. As illustrated, connection manager 230 may determine a change in connection type 405 and provide a connection type 410 to agent 200. For example, connection type 410 information may include information indicating a cellular connection, a home public land mobile network (PLMN) identifier, a third party PLMN identifier, and/or the like. In response, agent 200 may determine whether to reestablish a secure connection 415 based on the connection type 410 information and the criteria. According to this exemplary scenario, agent 200 may determine to terminate the secure connection associated with the Bluetooth connection and not establish a secure connection via the cellular connection.

FIG. 4 illustrates an exemplary process 400, however, according to other exemplary embodiments and scenarios, process 400 may include additional operations, fewer operations, and/or different operations. For example, as previously described, agent 200 may terminate a secure connection for reasons other than those associated with a handover. For example, agent 200 may dynamically terminate the secure connection due to inactivity. For example, agent 200 may terminate the secure connection when end device 130 enters a particular state (e.g., enters a sleep mode, enters a hibernate mode, etc.), remains in a particular state for a threshold period (e.g., remains in sleep or hibernate mode for a threshold period of time, remains in a Radio Resource Control (RRC) idle state for a threshold period of time, etc.), fails to transmit and/or receive a minimum number of packets during a threshold period, begins a pinging or a heartbeat procedure with respect to a network device, performs a pinging or a heartbeat procedure for a threshold period of time, or the like.

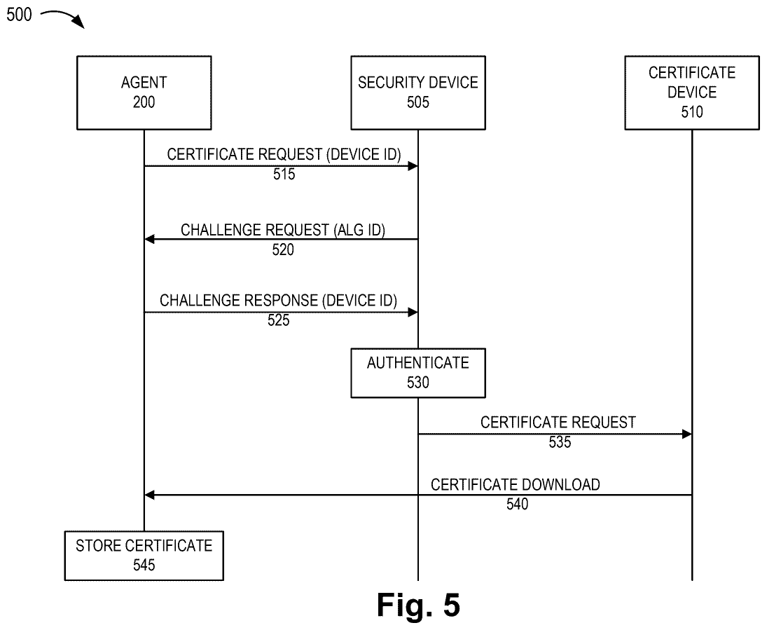

FIG. 5 is a messaging diagram illustrating an exemplary process 500 of an exemplary embodiment of the dynamic zero trust connection service. According to an exemplary scenario, agent 200 does not include security data (e.g., security certificates). For example, agent 200 may have been downloaded to end device 130 without security certificates.

As illustrated, agent 200 may generate and transmit a certificate request 515 to a security device 505. As previously described, agent 200 may establish a secure connection with security device 505. Agent 200 may be configured with a network address or network path to communicate with security device 505. Security device 505 may be implemented as a security gateway, for example, which may provide network-side services (e.g., zero trust services) associated with the dynamic zero trust connection service. Security device 505 may be implemented in network of the home network operator or the like associated with end device 130. As further illustrated, certificate request 515 may include an end device identifier, which was generated based on hashing algorithm 225 and unique identifiers 215. In response to receiving request 515, security device 505 may validate the end device identifier. According to this exemplary scenario, although not illustrated, security device 505 may determine that the end device identifier is valid but invokes a challenge procedure with end device 130/agent 200. For example, security device 505 may generate and transmit a challenge request 520 to agent 200. Challenge request 520 may include data indicating an algorithm identifier. For example, the algorithm identifier may indicate a particular hashing algorithm and a particular permutation of unique identifiers that differs from that associated with the end device identifier included in certificate request 515.

In response to receiving challenge request 520, agent 200 may select a hashing algorithm and unique identifiers from hashing algorithm 225 and unique IDs 215 based on the algorithm identifier. Agent 200 may generate a new end device identifier based on the selection. Agent 200 may generate and transmit a challenge response 525, which includes the new end device identifier value, to security device 505. In response to receiving challenge response 525, security device 505 may determine whether the end device identifier is valid or not. For example, security device 505 may generate its own end device identifier based on the algorithm identifier, and compare the resulting value to the end device identifier received from agent 200. When the end device identifiers match, security device 505 may determine that the end device identifier is valid and determine that agent 200 has been successfully authenticated. Otherwise, security device 505 may determine that agent 200 has not been successfully authenticated. Security device 505 may deny authentication, repeat another challenge procedure, or perform another type of remedial procedure. According to this exemplary scenario, security device 505 determines that agent 200 is authenticated 530. In response, security device 505 may generate a certificate request 535 to a certificate device 510. For example, certificate device 510 may manage and disburse security certificates. In response to receiving certificate request 535, a downloading procedure between certificate device 510 and agent 200 may be performed in which one or multiple certificates may be downloaded 540. Agent 200 may secure store the security certificates 545.

FIG. 5 illustrates an exemplary process 500, however, according to other exemplary embodiments and scenarios, process 500 may include additional operations, fewer operations, and/or different operations. For example, according to other exemplary embodiments, the challenge procedure may be omitted.

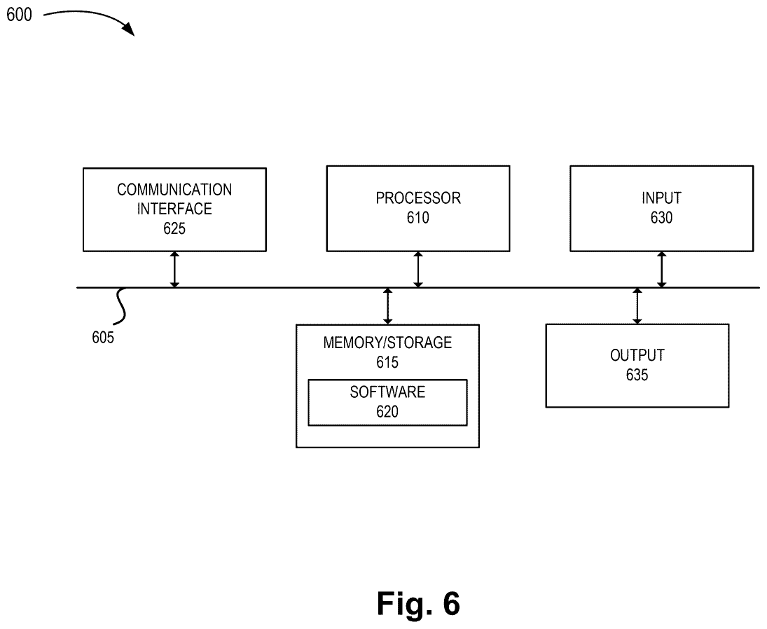

FIG. 6 is a diagram illustrating exemplary components of a device that may correspond to one or more of the devices illustrated and described herein. For example, device 600 may correspond to access device 107, external device 117, core device 122, end device 130, agent 200, security device 505, certificate device 510, and/or other types of devices, as described herein. As illustrated in FIG. 6, device 600 includes a bus 605, a processor 610, a memory/storage 615 that stores software 620, a communication interface 625, an input 630, and an output 635. According to other embodiments, device 600 may include fewer components, additional components, different components, and/or a different arrangement of components than those illustrated in FIG. 6 and described herein.

Bus 605 includes a path that permits communication among the components of device 600. For example, bus 605 may include a system bus, an address bus, a data bus, and/or a control bus. Bus 605 may also include bus drivers, bus arbiters, bus interfaces, clocks, and so forth.

Processor 610 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 610 may be implemented as hardware (e.g., a microprocessor, etc.), a combination of hardware and software (e.g., a SoC, an ASIC, etc.), may include one or multiple memories (e.g., cache, etc.), etc.

Processor 610 may control the overall operation, or a portion of operation(s) performed by device 600. Processor 610 may perform one or multiple operations based on an operating system and/or various applications or computer programs (e.g., software 620). Processor 610 may access instructions from memory/storage 615, from other components of device 600, and/or from a source external to device 600 (e.g., a network, another device, etc.). Processor 610 may perform an operation and/or a process based on various techniques and/or technologies including, for example, multithreading, parallel processing, pipelining, interleaving, machine learning, artificial intelligence, etc.

Memory/storage 615 includes one or multiple memories and/or one or multiple other types of storage mediums. For example, memory/storage 615 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 615 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 615 may be external to and/or removable from device 600, such as, for example, a Universal Serial Bus (USB) memory stick, a dongle, a hard disk, a solid state drive, mass storage, off-line storage, cloud storage, or some other type of storing medium. Memory/storage 615 may store data, software, and/or instructions related to the operation of device 600.

Software 620 includes an application or a program that provides a function and/or a process. As an example, with reference to end device 130, software 620 may include an application that, when executed by processor 610, provides a function and/or a process of dynamic zero trust connection service, as described herein. Additionally, with reference to agent 200, software 620 may include an application that, when executed by processor 610, provides a function and/or a process of dynamic zero trust connection service, as described herein. Software 620 may also include firmware, middleware, microcode, hardware description language (HDL), and/or other form of instruction. Software 620 may also be virtualized. Software 620 may further include an operating system.

Communication interface 625 permits device 600 to communicate with other devices, networks, systems, and/or the like. Communication interface 625 includes one or multiple wireless interfaces, optical interfaces, and/or wired interfaces. For example, communication interface 625 may include one or multiple transmitters and receivers, or transceivers. Communication interface 625 may operate according to a protocol stack and a communication standard.

Input 630 permits an input into device 600. For example, input 630 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 635 permits an output from device 600. For example, output 635 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 600 may be implemented in the same manner. For example, device 600 may be instantiated, created, deleted, or some other operational state during its life cycle (e.g., refreshed, paused, suspended, rebooting, or another type of state or status), using well-known virtualization technologies. For example, access device 107, core device 122, external device 117, and/or another type of network device or end device 130, as described herein, may be a virtualized device.

Device 600 may perform a process and/or a function, as described herein, in response to processor 610 executing software 620 stored by memory/storage 615. By way of example, instructions may be read into memory/storage 615 from another memory/storage 615 (not shown) or read from another device (not shown) via communication interface 625. The instructions that are stored by memory/storage 615 cause processor 610 to perform a function or a process described herein. Alternatively, for example, according to other implementations, device 600 performs a function or a process described herein based on the execution of hardware (processor 610, etc.).

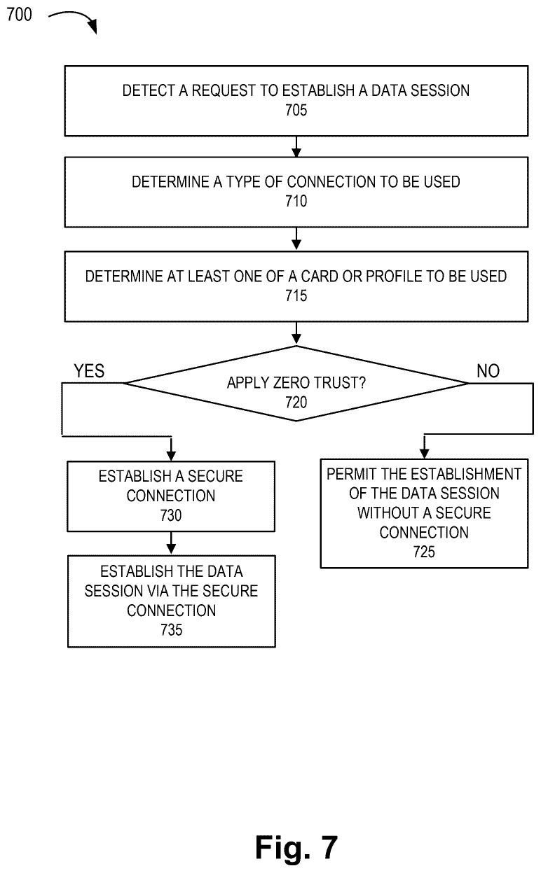

FIG. 7 is a flow diagram illustrating an exemplary process 700 of an exemplary embodiment of the dynamic zero trust connection service. According to an exemplary embodiment, end device 130 may perform a step of process 700. According to an exemplary implementation, processor 610 executes software 620 to perform a step of process 700, as described herein. Alternatively, a step may be performed by execution of only hardware. For purposes of description, process 700 is described as being performed by end device 130, which includes agent 200.

In block 705, end device 130 may detect a request to establish a data session. For example, end device application 240 may request access or establish a data session. By way of further example, a user of end device 130 may launch end device application.

In block 710, end device 130 may determine attributes associated with a wireless connection and/or the type of network to be used to support the data session. For example, end device 130 may determine whether the network connection is cellular or non-cellular and the type of network (e.g., home network, trusted third party network, foreign or non-trusted third party network.

In block 715, end device 130 may determine at least one of a card or a profile to be used to support the data session. For example, end device 130 may determine a card type, such as whether card 235 is a third party card or not, and whether the profile is associated with the home network operator, home network provider, or the like relative to end device 130.

In block 720, end device 130 may determine whether to apply zero trust to the data session based on criterion or criteria, as described herein. For example, end device 130 may determine whether zero trust is to be applied based on the criteria and connection type, card type, and/or profile type, as described herein. End device 130 may apply the criteria to the obtained information and determine whether the criteria is satisfied such that zero trust applies or does not apply.

When end device 130 determines to not apply zero trust (block 720-NO), end device 130 may permit the establishment of the data session without zero trust (block 725). For example, end device 130 may permit the establishment of the data session without a secure connection, as described herein.

When end device 130 determines to apply zero trust (block 720-YES), end device 130 may require that the data session be established with zero trust (block 730). For example, end device 130 may establish a secure connection via security device, such as security device 505. Alternatively, end device 130 may use an existing secure connection.

In block 735, end device 130 may establish the data session via the secure connection. For example, end device 130 may generate and transmit a session establishment request via the secure connection to a network device of relevance (e.g., access device 107, core device 122, external device 117, etc.), and establish the data session via a secure user plane.

FIG. 7 illustrates an exemplary process 700 of the dynamic zero trust connection service, according to other exemplary embodiments, the dynamic zero trust connection service may perform additional operations, fewer operations, and/or different operations than those illustrated and described. For example, process 700 may omit block 710 or block 715. By way of further example, when end device 130 determines that the connection type is Bluetooth® or Wi-Fi®, end device 130 may omit performing block 715. Alternatively, when end device 130 may determine that a third party card is being used, end device 130 may omit performing block 710.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. For example, the criteria for determining whether to apply or not apply zero trust may include criteria relating to the type of end device application. For example, when end device 130 may be cellularly connected to its home network and would otherwise not require zero trust based on the exemplary criteria, as described herein, agent 200 may apply zero trust for an end device application associated with a health service that may involve communication of sensitive data. For example, the additionally exemplary criteria may be further configured based on a category of end device applications (e.g., health-related, lifeline, etc.) or on an individual end device application basis. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks has been described regarding the process illustrated in FIG. 7, the order of the blocks may be modified according to other embodiments. Further, non-dependent blocks may be performed in parallel. Additionally, other processes described in this description and illustrated in the drawings may be modified and/or non-dependent operations may be performed in parallel.

Embodiments described herein may be implemented in many different forms of software executed by hardware. For example, a process or a function may be implemented as “logic” or a “component.” The logic or the component may include, for example, hardware (e.g., processor 610, etc.), or a combination of hardware and software (e.g., software 620).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 610) of a device. A non-transitory storage medium includes one or more of the storage mediums described in relation to memory/storage 615. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later become known are expressly incorporated herein by reference and are intended to be encompassed by the claims.

What is claimed is:

1. A method comprising:
detecting, by a device, a request to establish a data session;
determining, by the device, context information, wherein the context information includes at least one of a type of wireless connection, a type of card, or a type of profile of the card, to be used in support of the data session; and
determining, by the device based on the context information, whether to apply zero trust to the data session.

2. The method of claim 1, further comprising:
applying, by the device, zero trust in response to determining that zero trust is to be applied; and
establishing, by the device, the data session with zero trust.

3. The method of claim 1, further comprising
not applying, by the device, zero trust in response to determining that zero trust is not to be applied; and
establishing, by the device, the data session without zero trust.

4. The method of claim 1, wherein the type of wireless connection indicates a binary choice between cellular or non-cellular.

5. The method of claim 1, wherein the type of card indicates a binary choice between a third party card or not, wherein the card is one of a subscriber identity module (SIM), an embedded SIM, an integrated SIM, a Universal Integrated Circuit Card (UICC), an integrated UICC, or an embedded UICC.

6. The method of claim 1, wherein the type of profile indicates a binary choice between a third party profile or not.

7. The method of claim 1, wherein the type of wireless connection indicates a binary choice between a wireless connection to be used for the data session as it pertains to a third party network or a home network relative to the device.

8. The method of claim 1, wherein the device is one of a smartphone, a tablet, or a computer.

9. A device comprising:
a processor that is configured to:
detect a request to establish a data session;
determine context information, wherein the context information includes at least one of a type of wireless connection, a type of card, or a type of profile of the card, to be used in support of the data session; and
determine, based on the context information, whether to apply zero trust to the data session.

10. The device of claim 9, wherein the processor is further configured to:
apply zero trust, in response to a determination that zero trust is to be applied; and
establish the data session with zero trust.

11. The device of claim 9, wherein the processor is further configured to:
not apply zero trust, in response to a determination that zero trust is not to be applied; and
establish the data session without zero trust.

12. The device of claim 9, wherein the type of wireless connection indicates a binary choice between cellular or non-cellular.

13. The device of claim 9, wherein the type of card indicates a binary choice between a third party card or not, wherein the card is one of a subscriber identity module (SIM), an embedded SIM, an integrated SIM, a Universal Integrated Circuit Card (UICC), an integrated UICC, or an embedded UICC.

14. The device of claim 9, wherein the type of profile indicates a binary choice between a third party profile or not.

15. The device of claim 9, wherein the type of wireless connection indicates a binary choice between a wireless connection to be used for the data session as it pertains to a third party network or a home network relative to the device.

16. The device of claim 9, wherein the device is one of a smartphone, a tablet, or a computer.

17. A non-transitory computer-readable storage medium storing instructions executable by a processor of a device, wherein the instructions are configured to:
detect a request to establish a data session;
determine context information, wherein the context information includes at least one of a type of wireless connection, a type of card, or a type of profile of the card, to be used in support of the data session; and
determine, based on the context information, whether to apply zero trust to the data session.

18. The non-transitory computer-readable storage medium of claim 17, wherein the instructions are further configured to:
apply zero trust, in response to a determination that zero trust is to be applied; and
establish the data session with zero trust.

19. The non-transitory computer-readable storage medium of claim 17, wherein the type of card indicates a binary choice between a third party card or not, wherein the card is one of a subscriber identity module (SIM), an embedded SIM, an integrated SIM, a Universal Integrated Circuit Card (UICC), an integrated UICC, or an embedded UICC.

20. The non-transitory computer-readable storage medium of claim 17, wherein the type of wireless connection indicates a binary choice between cellular or non-cellular.
